(19) United States
(12) Patent Application Publication
(10) Pub. No.: US 2026/0298380 A1
(43) Pub. Date: Oct. 1, 2026

(54) PLUG CONNECTOR

(71) Applicant: Henn GmbH & Co KG., Dornbirn (AT)

(72) Inventor: Hannes KESSLER, Dornbirn (AT)

(73) Assignee: Henn GmbH & Co KG., Dornbirn (AT)

(21) Appl. No.: 19/472,220

(22) PCT Filed: Apr. 5, 2024
(86) PCT No.: PCT/AT2024/060121

§ 371 Date: Oct. 3, 2025

(30) Foreign Application Priority Data
Apr. 6, 2023 (AT) A50246/2023

(51) Int. Cl. F16L 37/086; F16L 37/084

(52) U.S. Cl. CPC F16L 37/086; F16L 37/0845; F16L 2201/10

(57) ABSTRACT

A plug connector for releasably connecting one fluid line to another using an insertion sleeve has a displacement sleeve displaceable between a lock-deactivating parked position and a lock-activating locking position. The lock includes a triggering spring with actuating and retaining portions. In parked position, the spring is biased into a retaining position latching the retaining portion on an inner sleeve retaining protrusion. In retaining position, the actuating portion projects radially inwards, through an inner sleeve actuating opening, into the inner sleeve receiving space, which allows the insertion sleeve to displace the actuating portion radially from the space to release the retaining portion from the protrusion and the spring to apply a triggering force on the displacement sleeve to shift it from parked into locking position where a displacement sleeve guide subjects the locking element to a guiding force to shift it from disengaged into arresting position.

The invention relates to a plug connector for releasably connecting a first fluid line to a second fluid line by means of an insertion sleeve, to an assembly comprising such a plug connector and to a use of the plug connector for connecting a first fluid line to a second fluid line.

Connectors of this type are used in a wide variety of industrial applications to connect two fluid lines, preferably in a sealed manner. This is usually done as part of an assembly process for a specific fluid-carrying product. Depending on the specific area of application and the fluid used, the fluid lines may be essentially rigid pipes or flexible hoses. However, a fluid line may also be integrated into a component. The fluids used may be gaseous media or liquid media. The gaseous media may be (pressurised) air or certain process gases, for example. Liquid media used include water, lubricating oil, coolant, refrigerant, etc.

During the assembly process of a product, it may be necessary, for example, to connect a first fluid line or a fluid connection of a component to be assembled to a corresponding fluid line or a corresponding fluid connection of the existing product. To avoid subsequent leaks, it is essential that the connection is made correctly with a high degree of reliability. Due to increasingly efficient production processes, the lead time in the assembly process is also generally shorter. This means that less and less time is available for the individual assembly steps. In addition to a high level of reliability, a quick connection of the fluid lines using the plug connector is therefore also desirable. Generally, one side of the connector is connected directly to one of the two fluid lines and the other fluid line is first connected to a insertion sleeve. To connect the two lines, the insertion sleeve is finally coupled to the plug connector, usually in a releasable manner.

Various plug connectors are known from WO 2018/144902A1, WO 2018/102213 A1 and EP 3 179 148A1. The plug connectors known from these documents have the disadvantage that the connection may be faulty or that it is not possible to clearly determine whether the plug connectors are correctly joined together.

The object of the present invention was to overcome the disadvantages of the prior art and to provide a plug connector which enables a reliable and quick connection between the plug connector and the insertion sleeve.

This object is achieved with a plug connector according to claim 1. The plug connector according to the invention enables the insertion sleeve to be automatically and reliably positively locked to the inner sleeve by the interaction of the triggering spring with the displacement sleeve and the locking element as soon as it is in the intended coupling position. The first guiding device achieves positive guidance of the locking element, which ensures reliable displacement of the locking element between the arresting position and the disengaged position.

Preferably, the displacement sleeve is manually displaceable from the locking position back into the parked position, preferably by means of a gripping portion provided on the outer circumferential surface, whereby a compression force opposing the release force can be transmitted to the triggering spring, whereby the retaining portion can be brought back into the retaining position, wherein the first guiding device of the displacement sleeve is configured in such a way that when the displacement sleeve is moved from the locking position into the parked position, a second guiding force acts on the locking element, by means of which the locking element can be displaced from the arresting position into the disengaged position. This makes it easy to deactivate the locking mechanism again, while the positive guidance ensures reliable unlocking.

In the area of the retaining portion, the triggering spring may have a restoring force directed inwards in the radial direction of the inner sleeve, which causes the retaining portion to engage on the retaining protrusion when the retaining position is reached. Alternatively or additionally, a restoring protrusion may be provided on the inner circumferential surface of the displacement sleeve, which is configured to exert a restoring force on the triggering spring when the displacement sleeve moves from the arresting position into the parked position, which force is directed inwards in the radial direction of the inner sleeve and causes the retaining portion of the triggering spring to engage on the retaining protrusion when the retaining position is reached. This makes it easier to engage the triggering spring in the retaining position. The restoring protrusion preferably has an inclined restoring surface facing the first displacement sleeve end.

Preferably, the triggering spring has a spring wire with a first free wire end, a second free wire end and with an intermediate central portion, wherein the central portion is at least in portions in contact with the outer circumferential surface of the inner sleeve and preferably extends in the circumferential direction over an angle of at least 30°, preferably at least 45°, particularly preferably at least 60°, especially at least 90°. The central portion may be essentially S-shaped or V-shaped. A fastening portion may be provided in the area of the first free wire end, which can be fastened to a fastening receptacle arranged on the outer circumferential surface of the inner sleeve in the area of the first axial inner sleeve end, wherein the retaining portion may be provided in the area of the second free wire end. This creates a structurally simple triggering spring, which is accommodated in the radial direction in a space between the displacement sleeve and the inner sleeve.

The locking recess is preferably configured as a circumferential groove and extends in the circumferential direction of the inner sleeve over a groove angle of at least 30°, preferably at least 60°, particularly preferably at least 90°. Particularly preferably, the circumferential groove lies in a plane that is normal to the longitudinal axis of the inner sleeve. An axial position of the locking recess on the inner sleeve is preferably determined depending on an axial position of the engagement opening of the insertion sleeve and/or an axial position of the actuating opening on the inner sleeve is preferably determined depending on an axial position of a conical portion of the insertion sleeve. This allows the locking mechanism to be adapted to a standardised insertion sleeve, in particular an insertion sleeve in accordance with the VDA standard.

Preferably, the first guiding device of the displacement sleeve comprises a first guiding link and a second guiding link, which are arranged at a distance from one another on the inner circumferential surface of the displacement sleeve in the circumferential direction of the displacement sleeve. The locking element preferably comprises a rod with a first free rod end and an opposite second free rod end, wherein a first guiding portion is provided in the region of the first rod end, which is positively guided in the first guiding slot, and a second guiding portion is provided in the region of the second rod end, which is positively guided in the second guiding slot, and wherein the arresting portion is disposed between the free rod ends. The embodiment allows a reliable guidance of the locking element on both sides and a stable locking.

It is advantageous if the locking mechanism comprises at least two locking mechanisms of the same type, which are arranged on the plug connector, preferably diametrically opposite each other, with respect to a longitudinal axis of the inner sleeve. The locking action is thus improved. At least two locking mechanisms of the same type can be actuated simultaneously.

It is advantageous if the connecting portion of the first axial inner sleeve end comprises a plurality of engagement recesses which are configured to co-operate with a plurality of corresponding engagement protrusions provided on the first fluid line in order to form a positive connection in the axial direction and/or in the circumferential direction. Alternatively or additionally, the connecting portion of the first axial inner sleeve end may comprise a plurality of engaging protrusions which are configured to co-operate with a plurality of corresponding engaging recesses provided on the first fluid line in order to form a positive connection in the axial direction and/or in the circumferential direction. This enables a stable, releasable connection with the first fluid line. The engaging recesses or engaging protrusions may, for example, be formed integrally with the inner sleeve and produced, for example, during the manufacture of the inner sleeve. This enables a simple and cost-effective production.

Preferably, a second guiding device is provided for axially guiding the displacement sleeve along the inner sleeve, the second guiding device preferably comprising at least one first guiding protrusion and at least one second guiding protrusion, which are arranged at a distance from one another in the circumferential direction on the outer circumferential surface of the inner sleeve and comprises a guiding web, which is provided on the inner circumferential surface of the displacement sleeve and extends in the axial direction over at least part of a length of the displacement sleeve, wherein the guiding web is guided in the circumferential direction between the first guiding protrusion and the second guiding protrusion. This enables a stable and reliable guidance of the displacement sleeve along the inner sleeve. The guiding protrusions may again be configured integrally with the inner sleeve and again produced directly during the manufacture of the inner sleeve. Preferably, the guiding web is integral with the restoring protrusion.

It is advantageous if a number of positioning recesses are provided on the inner sleeve, which each extend from the second axial inner sleeve end over a part of the inner sleeve in the direction of the first axial inner sleeve end and which each connect the inner circumferential surface with the outer circumferential surface of the inner sleeve, wherein the number of positioning recesses is configured to co-operate with a number of corresponding positioning protrusions provided on the insertion sleeve in order to position the insertion sleeve in the coupling position in the circumferential direction relative to the inner sleeve. This makes it easy to position the insertion sleeve relative to the inner sleeve, allowing the coupling position to be reached quickly and easily.

Preferably, the plug connector is provided with an indicating device to show a user whether the displacement sleeve is in the locking position and the locking element is in the arresting position. The indicating device may comprise a number of signal tabs which are arranged distributed around the circumference at the first axial inner sleeve end, wherein the number of signal tabs project beyond the first axial inner sleeve end in the axial direction, wherein the number of signal tabs each comprise a signal surface, wherein in the parked position of the displacement sleeve a first part of the signal surface is covered by the displacement sleeve and in the locking position of the displacement sleeve a smaller part of the signal surface relative to the first part is covered by the displacement sleeve or the signal surface is completely exposed. It may also be advantageous if a machine-readable code, preferably a QR code, is depicted on at least one of the signal surfaces, which can be read by machine when the displacement sleeve is in the locking position. This provides a simple and reliable way of recognising the locking state. The machine-readable code may be used, for example, during assembly via a reading device, e.g. a camera system, to recognise, preferably automatically, whether the plug connector has been properly locked.

For a better understanding of the invention, it is explained in more detail with the aid of the following figures.

The figures show a simplified, schematic representation as follows:

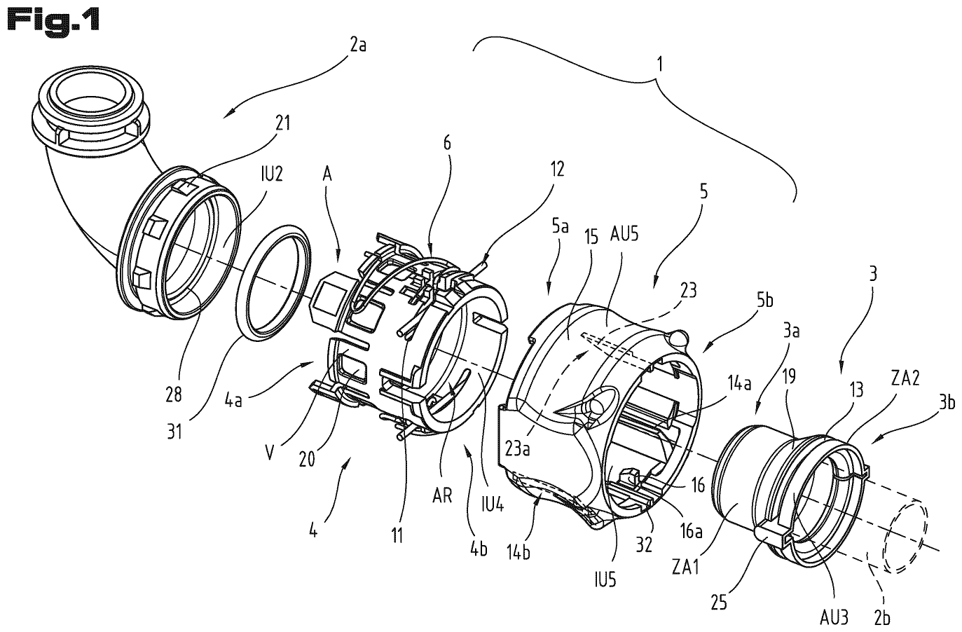

FIG. 1 an exploded view of the plug connector of an advantageous embodiment;

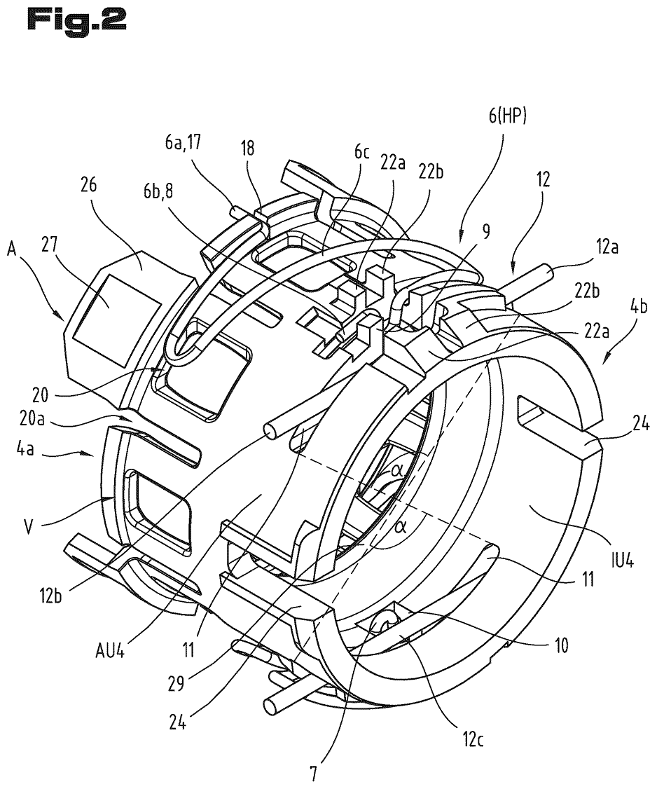

FIG. 2 the inner sleeve of the plug connector in a perspective view;

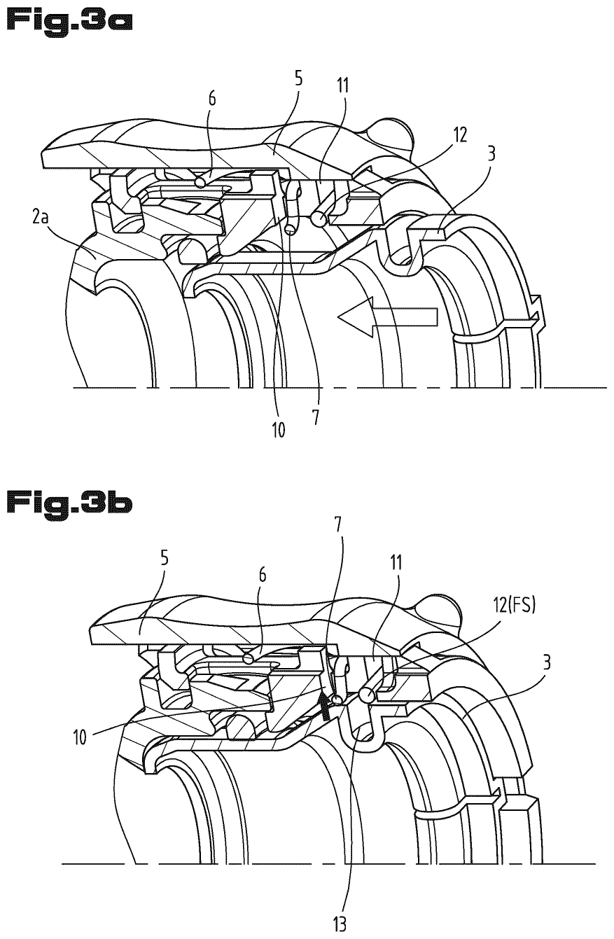

FIG. 3a a perspective longitudinal section through the plug connector before locking the insertion sleeve;

FIG. 3b a perspective longitudinal section through the plug connector during locking of the insertion sleeve;

FIG. 3c a perspective longitudinal section through the plug connector after locking the insertion sleeve;

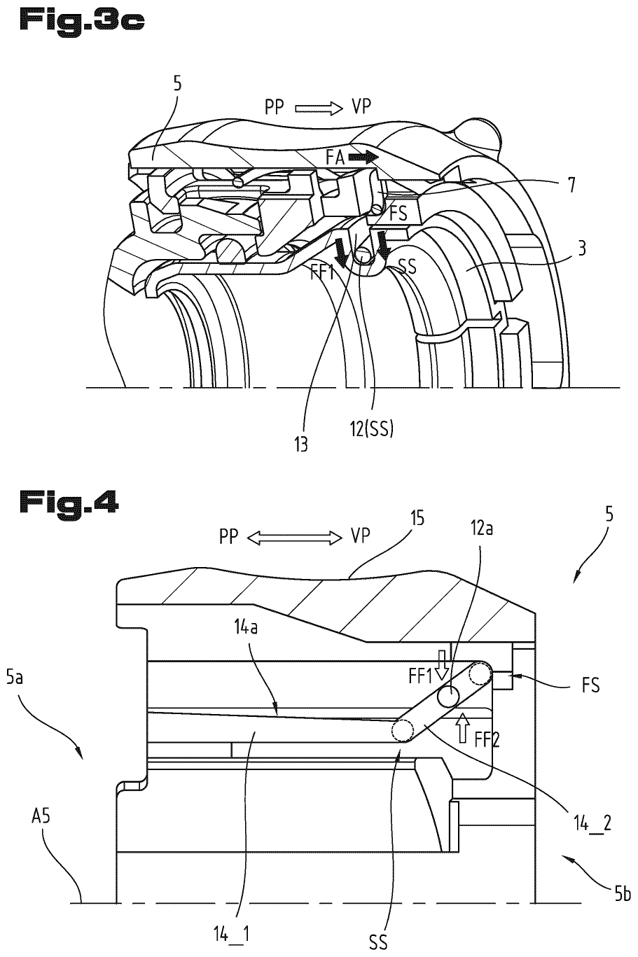

FIG. 4 a longitudinal section through the displacement sleeve of the plug connector including the locking element;

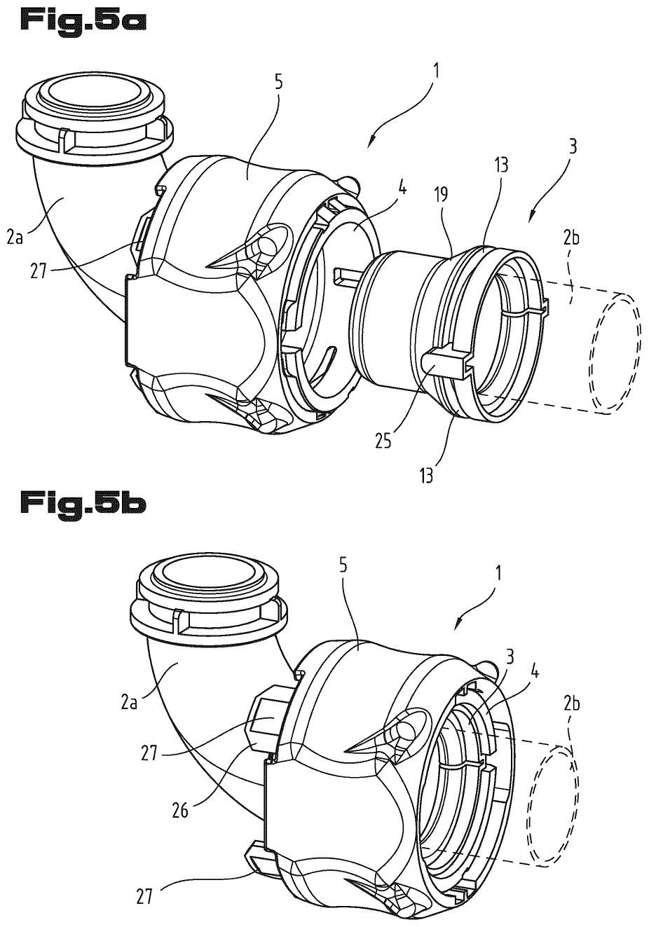

FIG. 5a a plug connector assembly in the uncoupled state of the insertion sleeve;

FIG. 5b a plug connector assembly in the coupled state of the insertion sleeve;

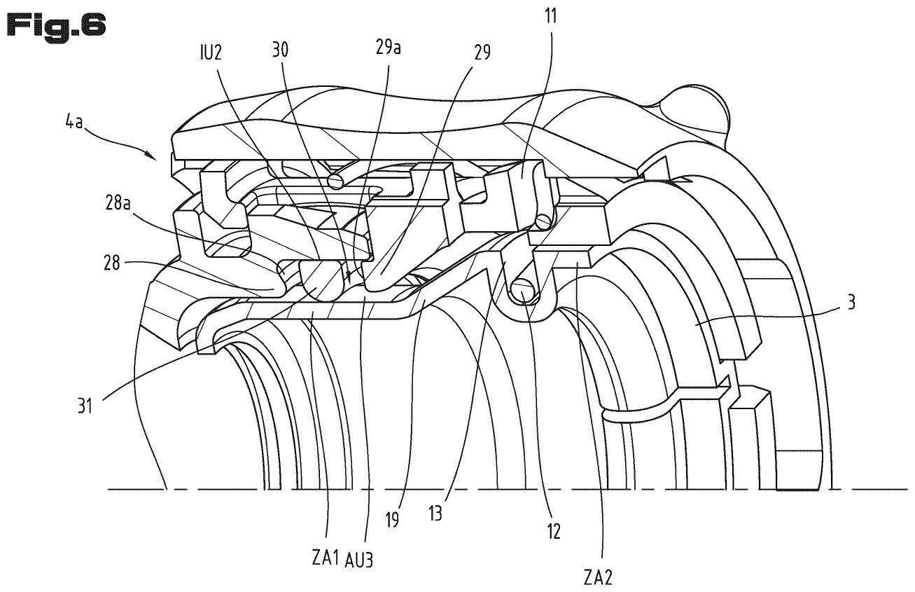

FIG. 6 a longitudinal section through the plug connector assembly in the locked state of the insertion sleeve.

By way of introduction, it should be noted that in the various embodiments described, the same parts are provided with the same reference signs or the same component designations, wherein the disclosures included in the entire description may be transferred analogously to the same parts with the same reference signs or the same component designations. The position details chosen in the description, such as top, bottom, side, etc., also refer to the directly described and illustrated figure and these position details are to be transferred to the new position accordingly in the event of a change of position.

FIG. 1 shows the plug connector 1 according to the invention in an advantageous, non-limiting embodiment in an exploded view. The plug connector 1 is used to releasably connect a first fluid line 2a to a second fluid line 2b by means of a insertion sleeve 3. The first fluid line 2a, the insertion sleeve 3 and the second fluid line 2b are not part of the present invention. The plug connector 1 has a substantially cylindrical inner sleeve 4 with an open first axial inner sleeve end 4a and an opposite open second axial inner sleeve end 4b. The inner sleeve 4 may, for example, be made of a suitable plastic or possibly also of a metallic material. The inner sleeve 4 of the plug connector 1 is shown in detail in FIG. 2.

In the following description, reference is made to FIG. 1 to FIG. 6, wherein the same reference symbols or component designations are used for identical parts. To avoid unnecessary repetition, reference is made to the detailed description in the respective preceding figures.

A connecting portion V for connecting the inner sleeve 4 to the first fluid line 2a is provided in the area of the first axial inner sleeve end 4a. In the example shown, the connecting portion V has a number of engagement recesses 20, which are configured to co-operate with a number of corresponding engagement protrusions 21 provided on the first fluid line 2a in order to form a positive connection. As shown, a plurality of engagement recesses 20 may be provided around the circumference. With this configuration, the positive connection can be created in the axial direction and in the circumferential direction.

Of course, the reverse configuration (not shown) would also be conceivable, in which a number of engaging protrusions 21 are provided on the connecting portion V of the first axial inner sleeve end 4a, which are configured to co-operate with a number of corresponding engaging recesses 20 provided on the first fluid line 2a in order to form a positive connection. A combination of engaging protrusions 21 and engaging recesses 20 would of course also be conceivable.

In the circumferential direction, for example, a recess 20a may be provided in each case between two successive engagement recesses 20 (or engagement protrusions 21), which extends from the first axial inner sleeve end 4a over a part of a length of the inner sleeve 4 in the direction of the second axial inner sleeve end 4b (see FIG. 2). This creates a separate bending tab for each engaging recess 20, which enables a certain elasticity in the radial direction. The bending tabs can be bent outwards when connecting to the first fluid line 2a, making it easier to engage with the engagement protrusions 21. However, the illustrated configuration of the connecting portion V is only to be understood as an example. In principle, the skilled person could also choose another suitable form of connection.

The second axial inner sleeve end 4b of the inner sleeve 4 encloses a receiving space AR, into which an open first axial insertion sleeve end 3a of the insertion sleeve 3 can be inserted axially. An opposite open second axial insertion sleeve end 3b of the insertion sleeve 3 can be connected to the second fluid line 2b. The insertion sleeve 3 is not part of the invention and may, for example, be a standardised component, as will be explained in detail later. Depending on the configuration of the insertion sleeve 3, the second fluid line 2b may also be configured differently. The second fluid line 2b is only indicated by a dashed line in FIG. 2.

Furthermore, the plug connector 1 has a locking mechanism for positive locking of the insertion sleeve 3 with the inner sleeve 4. In the example shown, the locking mechanism comprises, for example, two locking mechanisms of the same type, which are arranged diametrically opposite each other on the plug connector 1 with respect to a longitudinal axis of the inner sleeve 4. Of course, more than two locking mechanisms, preferably of the same type, would also be conceivable. For the sake of simplicity, the invention is described by means of one locking mechanism. If a plurality of locking mechanisms is provided, it is advantageous for easy handling if they can be actuated simultaneously for locking and unlocking.

The locking mechanism comprises at least one locking recess 11 and at least one locking element 12. The locking recess 11 connects an outer circumferential surface AU4 of the inner sleeve 4 with the receiving space AR. When the insertion sleeve 3 is in a defined coupling position in the receiving space AR of the inner sleeve 4 (see FIG. 3c), the locking element 12 can be moved within the locking recess 11 between a arresting position SS, in which a arresting portion 12c (see FIG. 2) of the locking element 12 is engaged with an engagement opening 13 arranged on the insertion sleeve 3, and a disengaged position FS, in which the arresting portion 12c is not engaged with the engagement opening 13. When the locking element 12 is engaged with the engagement opening 13, the insertion sleeve 3 is positively connected to the inner sleeve 4 or locked to it, at least in the axial direction. Depending on the configuration of the locking element 12 and the engagement opening 13, positive locking in the circumferential direction may also be possible.

As may be seen in FIG. 1 and in detail in FIG. 2, the locking recess 11 is preferably configured as a circumferential groove. The circumferential groove may extend in the circumferential direction of the inner sleeve 4, for example, over a groove angle α of at least 30°, preferably at least 60°, particularly preferably at least 90°. The circumferential groove preferably lies in a plane that is normal to the longitudinal axis of the inner sleeve 4.

An axial position of the locking recess 11 on the inner sleeve 4 may, for example, be determined as a function of an axial position of the engagement opening 13 of the insertion sleeve 3. In general, the dimensions of the inner sleeve 4, e.g. an axial length and an inner diameter of the receiving space AR, may be based on the dimensions of a standardised insertion sleeve 3, for example. FIG. 1 shows an example of an insertion sleeve 3 configured in accordance with a preferred standard of the German Association of the Automotive Industry (Verband der Automobilindustrie, VDA).

The illustrated insertion sleeve 3 is provided with a first cylindrical portion ZA1 in the area of the first axial insertion sleeve end 3a. The first cylindrical portion ZA1 is connected to a second cylindrical portion ZA2 via a conical portion 19. The second cylindrical portion ZA2 has a larger diameter than the first cylindrical portion ZA1. The engagement 13 is arranged on an outer circumferential surface AU3 of the second cylindrical portion ZA2 and is groove-shaped. In the example shown, two engagement openings 13 are provided, which are arranged diametrically opposite each other and each extend over a certain angle in the circumferential direction. Each engagement opening 13 interacts with a locking mechanism of the plug connector 1, in particular with a locking element 12. Of course, this embodiment is only exemplary and the engagement opening 13 could also comprise only a single circumferential groove extending around the entire circumference.

According to the invention, the plug connector 1 is provided with a displacement sleeve 5 disposed outside the inner sleeve 4 in the radial direction, which can be moved in the axial direction along the inner sleeve 4 between a parked position PP (see FIG. 5a), in which the locking mechanism is deactivated, and a locking position VP (see FIG. 5b), in which the locking mechanism is activated. Before the plug connector 1 can be coupled with the insertion sleeve 3, the displacement sleeve 5 should of course be in the parked position PP or be moved from the locking position VP to the parked position PP. This may be done manually by a user, e.g. using the gripping portion 15.

The locking mechanism also has a triggering spring 6 with an triggering portion 7 and a retaining portion 8. When the displacement sleeve 5 is in the parked position PP, the triggering spring 6 is pretensioned in a retaining position HP, in which the retaining portion 8 is engaged on a retaining protrusion 9 of the inner sleeve 4, as shown in FIG. 2 and FIG. 3a.

An actuating opening 10 is also provided on the inner sleeve 4, which connects the outer circumferential surface AU4 to the receiving space AR. The actuating opening 10 is disposed between the locking recess 11 and the first axial inner sleeve end 4b when viewed in the axial direction of the inner sleeve 4. The actuating opening 10 may be seen in FIG. 2 on the lower locking mechanism. When the triggering spring 6 is in the retaining position HP, the actuating portion 7 projects radially inwards through the actuating opening 10 into the receiving space AR of the inner sleeve 4, as may also be seen in FIG. 2 on the lower locking mechanism.

When the insertion sleeve 3 is inserted in the axial direction into the receiving space AR of the inner sleeve 4 to create the locking (as indicated by the arrow in FIG. 3a), the actuating portion 7 of the triggering spring 6 is displaced from the receiving space AR in the radial direction by the insertion sleeve 3, for example by the conical portion 19, as indicated by the arrow in FIG. 3b. As a result, the retaining portion 8 of the triggering spring 6 is released from the retaining protrusion 9 of the inner sleeve 4 and a triggering force FA directed towards the second axial inner sleeve end 4b is exerted on the displacement sleeve 5 by the triggering spring 6, as shown in FIG. 3c.

A force absorption protrusion 5v, on which the triggering spring 6 acts, may be arranged on an inner circumferential surface IU5 of the displacement sleeve 5 for this purpose (FIG. 3b). As a result of the triggering force FA (indicated by an arrow in FIG. 3c), the displacement sleeve 5 is automatically displaced (provided it is not blocked) from the parked position PP to the locking position VP.

Similarly to the position of the locking recess 11, an axial position of the actuating opening 10 on the inner sleeve 4 may also be defined as a function of an axial position of a conical portion 19 of the preferably standardised insertion sleeve 3. This ensures that the actuating portion 7 of the triggering spring 6 is reliably actuated and displaced from the receiving space AR when the insertion sleeve 3 is inserted into the receiving space AR.

According to an advantageous embodiment of the invention, the triggering spring 6 in the area of the retaining portion 8 has a restoring force directed inwards in the radial direction of the inner sleeve 4. Due to this restoring force, the retaining portion 8 engages better on the retaining protrusion 9 when the retaining position HP is reached.

Alternatively or additionally, it may be advantageous if a restoring protrusion 23 is provided on the inner circumferential surface IU5 of the displacement sleeve 5. When the displacement sleeve 5 moves from the locking position VP to the parked position PP, the restoring protrusion 23 is configured to exert an inwardly directed restoring force on the triggering spring 6 in the radial direction of the inner sleeve 4, which causes the retaining portion 8 of the triggering spring 6 to engage on the retaining protrusion 9 when the retaining position HP is reached. In the example shown in FIG. 1, the displacement sleeve 5 comprises two diametrically opposed restoring protrusions 23, one restoring protrusion 23 for each locking mechanism.

The restoring protrusion 23 may, for example, be configured as an elongated web which, starting from the second displacement sleeve end 5b, extends over a part of the length of the displacement sleeve 5 in the direction of the first displacement sleeve end 5a. At an end of the web facing the first displacement sleeve end 5a, an inclined restoring surface 23a may be provided, which is configured to co-operate with the triggering spring 6, in particular the central portion 6c described below—see FIG. 2—to generate the restoring force. The restoring surface 23a may be seen in FIG. 1 on the upper restoring protrusion 23.

In the example shown, the triggering spring 6 is made of a spring wire and has a first free wire end 6a, a second free wire end 6b and a central portion 6c in between (see FIG. 2). As may be seen in FIG. 2, the central portion 6c is in contact with the outer circumferential surface UA4 of the inner sleeve 4, at least in portions. In the circumferential direction, the central portion 6c may, for example, extend over an angle of at least 30°, preferably at least 45°, particularly preferably at least 60°, especially at least 90°. In the example shown, the central portion 6c (in plan view) is essentially S-shaped and has two bends. However, the central portion 6c could (in plan view) also be essentially V-shaped, for example, and only have an arc.

In the area of the first free wire end 6a, a fastening portion 17 may be provided, which is fastened to a fastening receptacle 18, which is arranged on the outer circumferential surface AU4 of the inner sleeve 4 in the area of the first axial inner sleeve end 4a. As may be seen in FIG. 2, the inner sleeve may have a radially protruding collar at the first axial inner sleeve end 4a, which extends over a certain portion in the circumferential direction. An axial recess may be provided in this collar, which can serve as a fastening receptacle 18. The retaining portion 8 may be provided in the area of the second free wire end 6b. The actuating portion 7 may also be provided in the area of the second free wire end 6b and may, for example, be configured by a U-shaped portion of the spring wire.

According to a further advantageous embodiment, a stop protrusion 16 may be provided on the inner circumferential surface IU5 of the displacement sleeve 5, which is configured to form a stop for the second free wire end 6b of the triggering spring 6 in the circumferential direction. The stop protrusion 16 is shown in FIG. 1. The stop protrusion 16 may have a stop surface 16a, which faces the second free wire end 6b of the triggering spring 6 in the circumferential direction when the displacement sleeve 5 is in the parked position PP.

An end face of the second free wire end 6b of the triggering spring 6, which limits the second free wire end 6b in the circumferential direction, may rest against the stop face 16a of the stop protrusion 16, whereby an undesired movement of the triggering spring 6 in the circumferential direction can be prevented. The end face of the second free wire end 6b is only visible on the upper triggering spring 6 in FIG. 1 and FIG. 2. For the upper triggering spring 6, a stop protrusion 16 (not shown) may of course be provided in the same way, which may be arranged diametrically opposite the lower stop protrusion 16 shown in FIG. 1 on the inner circumferential surface IU5 of the displacement sleeve 5.

A first guiding device 14 for guiding the locking element 12 is also provided on the displacement sleeve 5. The first guiding device 14 is configured such that when the displacement sleeve 5 is moved from the parked position PP into the locking position VP, a first guiding force FF1 acts on the locking element 12, by means of which the locking element 12 (if it is not blocked) is displaced from the disengaged position FS into the arresting position SS, as indicated by the arrow in FIG. 3c. When the insertion sleeve 3 is in the coupling position shown in FIG. 3c, the engagement opening 13 is aligned in the radial direction with the locking recess 11 and the locking element 12 can be brought into engagement with the engagement opening 13 in order to produce the positive locking.

In the example shown, the first guiding device 14 of the displacement sleeve 5 has a first guiding link 14a and a second guiding link 14b, which are arranged at a distance from one another on the inner circumferential surface IU5 of the displacement sleeve 5 in the circumferential direction of the displacement sleeve 5 (see FIG. 1). The first guiding link 14a of the first guiding device 14 of the lower locking mechanism is shown in FIG. 1. The opposite second guiding link 14b of the first guiding device 14 of the lower locking mechanism is not visible in FIG. 1 and is therefore indicated by a dashed line. The two guiding links 14a, 14b of the first guiding device 14 of the upper locking mechanism are configured in the same way, but are not shown in FIG. 1.

In the example shown, the locking element 12 is provided with a cylindrical rod with a first free rod end and an opposite second free rod end. A first guiding portion 12a is provided in the area of the first free end of the rod and a second guiding portion 12b is provided in the area of the second free end of the rod. As may be seen in FIG. 2, the locking element 12 is arranged in the groove-shaped locking recess 11 in such a way that the cylindrical rod is arranged essentially tangentially with respect to the inner sleeve 4. A length of the cylindrical rod is dimensioned such that the first guiding portion 12a and the second guiding portion 12b are located outside the circumference of the inner sleeve 4 both in the disengaged position FS and in the arresting position SS and project beyond the outer circumferential surface UA4 of the inner sleeve 4.

When the displacement sleeve 5 is mounted on the inner sleeve 4, the first guiding portion 12a is accommodated in the first guiding slot 14a and forcibly guided by the first guiding slot 14a. In the same way, the second guiding portion 12b is accommodated in the second guiding link 14b and forcibly guided by the second guiding link 14b. The arresting portion 12c, which is in engagement with the engagement opening 13 of the insertion sleeve 3 on the inner sleeve 4 when the insertion sleeve 3 is in the locked state, is located in a central area between the free rod ends or the guiding portions 12a, 12b (see FIG. 2).

The function of the first guiding device 14 is explained in more detail below with reference to FIG. 4. FIG. 4 shows a longitudinal section through the displacement sleeve 5 including the rod-shaped locking element 12. For the sake of simplicity, only the upper half of the displacement sleeve 5 is shown. As mentioned above, the first guiding device 14 has a first guiding link 14a and a second guiding link 14b (not shown in FIG. 4) which is normally located opposite the drawing plane. The second guiding link 14b is essentially identical in configuration to the first guiding link 14a.

The displacement sleeve 5 can be moved in an axial direction along the inner sleeve 4 between the parked position PP (left in FIG. 4) and the locking position VP (right in FIG. 4). Because the locking element 12 is accommodated in the locking recess 11 of the inner sleeve 4 (not shown), the locking element 12 is fixed in the axial direction relative to the inner sleeve 4. In the radial direction, the locking element 12 is movable within the locking recess 11 relative to the inner sleeve 4 between the disengaged position FS (see FIG. 3b) and the arresting position SP (see FIG. 3c).

The first guiding link 14a and the second guiding link 14b (not shown) have a groove-shaped configuration and each have a first link portion 14_1 and a second link portion 14_2, as may be seen in FIG. 4. The first link portion 14_1 is connected here to the first axial displacement sleeve end 5a of the displacement sleeve 5 in order to facilitate the assembly of the displacement sleeve 5 on the inner sleeve 4.

The first link portion 14_1 is essentially straight and extends over a part of the length of the displacement sleeve 5 in the direction of the opposite second axial displacement sleeve end 5b of the displacement sleeve 5. The first link portion 14_1 runs essentially parallel to the longitudinal axis A5 of the displacement sleeve 5. As may be seen in FIG. 4, the first link portion 14_1 may also have a conical shape and taper from the first axial displacement sleeve end 5a in the direction of the second axial displacement sleeve end 5b.

The second link portion 14_2 is adjacent to the first link portion 14_1 and has also here a straight configuration and is inclined at an angle to the first link portion 14_1. The second link portion 14_2, in particular the walls of the groove facing each other, thus forms a kind of inclined plane for guiding the first guiding portion 12a of the locking element 12. The end of the second link portion 14_2 facing the second axial displacement sleeve end 5b of the displacement sleeve 5 is preferably closed. However, the configuration shown is merely exemplary and the first guiding slot 14a could, for example, also have a curved course.

When the displacement sleeve 5 is in the parked position PP, the locking element 12 is in the disengaged position FS and is received in the second link portion 14_2 of the first guiding link 14a, as shown dashed in FIG. 4. When the displacement sleeve 5 is in the locking position VP, the locking element 12 is in the locking position SS and is accommodated in the first link portion 14_1 of the first guiding link 14a, as also shown in dashed lines in FIG. 4.

When the displacement sleeve 5 is in a position between the parked position PP and the locking position VP, the locking element 12 is in a position between the disengaged position FS and the arresting position SS (shown solid in FIG. 4). However, the illustration only serves to visualise the radial position of the locking element 12. The axial position of the locking element 12 remains unchanged during operation, as the locking element 12 is accommodated in the locking recess 11.

When the displacement sleeve 5 is moved from the parked position PP to the locking position VP as a result of the triggering force FA of the triggering spring 6 (see FIG. 3c), a first guiding force FF1 is exerted on the locking element 12 by the second link portion 14_2 of the first guiding link 14a (directed downwards in FIG. 4, as indicated by the arrow). The first guiding force FF1 moves the locking element 12 from the disengaged position FS to the arresting position SS.

To release the locking, the displacement sleeve 5 may be moved manually from the locking position VP back to the parked position PP, preferably by means of a gripping portion 15 provided on the outer circumferential surface AU5. As a result, a compression force opposite to the triggering force FA is transmitted from the displacement sleeve 5, for example from the force absorption protrusion 5v, to the triggering spring 6, whereby the retaining portion 8 can be brought back into the retaining position HP.

The first guiding device 14 of the displacement sleeve 5 is configured in such a way that when the displacement sleeve 5 moves from the locking position VP to the parked position PP, a second guiding force FF2 is exerted on the locking element 12 by the second link portion 14_2 of the first guiding link 14a (directed upwards in FIG. 4, as indicated by the arrow). The second guiding force FF2 moves the locking element 12 from the arresting position SS to the disengaged position FS.

In order to improve the axial guidance of the displacement sleeve 5 along the inner sleeve 4, it is advantageous if at least a second guiding device 22 is provided. In the example shown, two second guiding devices 22 are provided, which are arranged diametrically opposite each other on the plug connector 1. The second guiding device 22 preferably has at least one first guiding protrusion 22a and at least one second guiding protrusion 22b, which are arranged spaced apart from one another in the circumferential direction on the outer circumferential surface AU4 of the inner sleeve 4. In the example shown, for example, two axially spaced-apart first guiding protrusions 22a and two axially spaced-apart second guiding protrusions 22b are provided. The guiding protrusions 22a, 22b are preferably integrally formed with the inner sleeve 4.

The second guiding device 22 further comprises a guiding web 32, which is provided on the inner circumferential surface IU5 of the displacement sleeve 5 and which extends in the axial direction over at least a part of a length of the displacement sleeve 5. In the example shown, two guiding webs 32 are provided, each extending from the second axial displacement sleeve end 5b over a part of the length of the displacement sleeve 5 in the direction of the first axial displacement sleeve end 5b. The guiding webs 32 may be seen in FIG. 1, wherein only the front end of the guiding web 32 shown in FIG. 1 above is visible and the rest is invisible and is therefore shown in stroke-dotted lines. When the displacement sleeve 5 is mounted on the inner sleeve 4, a respective guiding web 32 is arranged in the circumferential direction between the respective at least one first guiding protrusion 22a and the respective at least one second guiding protrusion 22b and is guided by the guiding protrusions 22a, 22b.

As may be seen in FIG. 1, the guiding web 32 and the restoring protrusion 23 may be configured as an integral web. A portion of the web facing the second displacement sleeve end 5b can function as a guiding web 32 and a portion of the web facing the first displacement sleeve end 5a (on which the inclined restoring surface 23a is provided) can function as a restoring protrusion 23.

According to a further advantageous embodiment, a plurality of positioning recesses 24 is provided on the inner sleeve 4, which each extend from the second axial inner sleeve end 4b over a part of the inner sleeve in the direction of the first axial inner sleeve end 4a and which each connect the inner circumferential surface IU4 to the outer circumferential surface AU4 of the inner sleeve 4 (see FIG. 2). The plurality of positioning recesses 24 is configured to co-operate with a plurality of corresponding positioning protrusions 25 provided on the insertion sleeve 3 (see FIG. 1) in order to position the insertion sleeve 3 in the coupling position in the circumferential direction relative to the inner sleeve 4. Number, position and size of the positioning recesses 24 are preferably determined by the configuration of the insertion sleeve 3. In the example shown, two positioning recesses 24 are provided, which are arranged diametrically opposite each other on the inner sleeve 4.

According to a further advantageous embodiment of the invention, the plug connector 1 comprises an indicator device A to indicate to a user whether the displacement sleeve 5 is in the locking position VP and consequently whether the locking element 12 is in the locking position SS. In the example shown, the indicator device A is provided with a plurality of signal tabs 26 (e.g. four), which are distributed around the circumference of the first axial inner sleeve end 4a. The plurality of signal tabs 26 may project beyond the first axial inner sleeve end 4a in the axial direction. The plurality of signal tabs 26 may each comprise a signal surface 27, wherein in the parked position PP of the displacement sleeve 5 a first part of the signal surface 27 is covered by the displacement sleeve 5 and in the locking position VP of the displacement sleeve 5 a smaller part of the signal surface 27 relative to the first part is covered by the displacement sleeve 5 or the signal surface 27 is completely exposed.

It is advantageous if a machine-readable code, preferably a QR code, is depicted on at least one of the signal surfaces 27, which can be read by machine when the displacement sleeve 5 is in the locking position VP. This allows automatic detection of whether the insertion sleeve 3 has been properly coupled with the plug connector 1. The detection may be carried out using a camera system and industrial image processing, for example.

FIG. 5a shows a plug connector assembly comprising the plug connector 1, the first fluid line 2a, the insertion sleeve 3 and the second fluid line 2b. The first fluid line 2a is mounted on the plug connector 1 by engaging the engaging protrusions 21 of the first fluid line 2a in the engaging recesses 20 of the connecting portion V of the inner sleeve 4. Furthermore, the insertion sleeve 3 is connected to the second fluid line 2b. The second fluid line 2b is only indicated schematically. In FIG. 5a, the insertion sleeve 3 is not coupled to the plug connector 1 and the displacement sleeve 5 is in the parked position PP. In the parked position PP, at least some of the signal surfaces 27 of the signal tabs 26 are covered by the displacement sleeve 5 and are not visible from the outside. This means that a QR code depicted on the signal areas 27 is partially covered and cannot be read.

FIG. 5b shows the plug connector assembly in the coupled state of the insertion sleeve 3 with the plug connector 1. The displacement sleeve 5 is in the locking position VP, in which the two locking elements 12 (generally the at least one locking element 12) are in the locking position SS, as shown in FIG. 3c. In the locking position SS, the locking portions 12c of the locking elements 12 are in engagement with the respective engagement opening 13 of the insertion sleeve 3. The positioning protrusions 25 of the insertion sleeve 3 are in engagement with the positioning recesses 24 of the inner sleeve 4, which ensures that the insertion sleeve 3 is in the correct coupling position in the circumferential direction.

As may also be seen in FIG. 5b, the displacement sleeve 5 is arranged in the locking position VP relative to the inner sleeve 4 in the axial direction in such a way that the second axial displacement sleeve end 5b of the displacement sleeve 5 projects beyond the second axial inner sleeve end 4b of the inner sleeve 4. As a result, a larger part of the signal surfaces 27 of the signal tabs 26 is exposed than in the parked position PP (according to FIG. 5a) so that a QR code depicted on it can be read. Preferably, the signal surfaces 27 are essentially completely exposed. Reading in may be automated or carried out manually by an assembler, e.g. using a suitable camera or a QR code scanner. If the QR code cannot be read, this means that the displacement sleeve 5 has not reached the locking position VP and the coupling process has therefore not been carried out correctly. The information may be used, for example, to repeat the coupling process until correct coupling is achieved.

FIG. 6 shows a longitudinal section through the plug connector assembly in the coupled state of the insertion sleeve 3. The illustration in FIG. 6 essentially corresponds to the illustration in FIG. 3c. On an inner circumferential surface IU2 of an end portion of the first fluid conduit 2a, a first circumferential shoulder 28 is provided with a first annular end surface 28a, which faces the open end of the first fluid conduit 2a in the axial direction. Furthermore, a second circumferential shoulder 29 with a second annular end face 29a is provided on the inner circumferential surface IU4 of the inner sleeve 4, which faces the first open inner sleeve end 4a in the axial direction.

Viewed in the axial direction between the first annular end face 28a and the second annular end face 29a and viewed in the radial direction between the inner circumferential surface IU2 of the end portion of the first fluid line 2a and the outer circumferential surface AU3 of the first cylindrical portion ZA1 of the insertion sleeve 3, a sealing space 30 is formed in which a sealing element 31 is arranged. The sealing element 31 shown has a substantially cylindrical outer circumferential surface, which is contact with the inner circumferential surface of the end portion of the first fluid line 2a. This allows the sealing element 31 to be pre-assembled on the first fluid line 2a, for example.

The inner circumferential surface is convex or rounded and is in contact with the outer circumferential surface AU3 of the first cylindrical portion ZA1 of the insertion sleeve 3. The sealing element 31 can create a seal between the insertion sleeve 3 and the first fluid line 2a when the insertion sleeve 3 is coupled. For example, a sealing ring made of a suitable material may be used as the sealing element 31, wherein different materials may also be used depending on the application (e.g. depending on pressure, temperature, type of fluid, etc.), e.g. rubber, silicone, etc.

The exemplary embodiments show possible embodiment variants, wherein it should be noted at this point that the invention is not limited to the specifically illustrated embodiment variants thereof, but rather various combinations of the individual embodiment variants with one another are also possible and this variation possibility lies within the ability of the skilled person working in this technical field due to the teaching on technical action by the present invention.

The scope of protection is determined by the claims. However, the description and the drawings should be consulted to interpret the claims. Individual features or combinations of features from the various exemplary embodiments shown and described may constitute inventive solutions in their own right. The object underlying the independent inventive solutions may be taken from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### List of reference signs

1 plug connector 21 engaging protrusion
2a first fluid line 22 second guiding device
2b second fluid line 22a first guiding protrusion
3 insertion sleeve 22b second guiding protrusion
3a first axial insertion sleeve end 23 restoring protrusion
3b second axial insertion sleeve end 23a restoring surface
4 inner sleeve 24 positioning recess
4a first axial insertion sleeve end 25 positioning protrusion
4b second axial insertion sleeve end 26 signal tab
5 displacement sleeve 27 signal area
6 triggering spring 28 first circumferential shoulder
7 actuating portion 28a first annular end face
8 retaining portion 29 second circumferential shoulder
9 retaining protrusion 29a second annular end face
10 actuating opening 30 sealing space
11 locking opening 31 sealing element
12 locking element 32 guiding web
12a first guiding portion IU2 inner circumferential surface of the end
12b second guiding portion portion of the first fluid line
12c arresting portion IU4 inner circumferential surface of the inner
13 engagement opening sleeve
14 first guiding device IU5 inner circumferential surface of
14a first guiding link the displacement sleeve
14b second guiding link AU3 outer circumferential surface of the
15 gripping portion insertion sleeve
16 stop protrusion AU4 outer circumferential surface of the inner
16a stop surface sleeve
17 fastening portion AU5 outer circumferential surface of the
18 fastening receptacle displacement sleeve
19 conical portion V connecting portion
20 engaging recess PP Parked position
VP locking position
AR receiving space
FS disengaged position
SS arresting position
FA triggering force
FF first guiding force
FF2 second guiding force
HP retaining position
ZA1 first cylindrical portion
ZA2 second cylindrical portion
α groove angle

1. A plug connector (1) for releasably connecting a first fluid line (2a) to a second fluid line (2b) by means of a insertion sleeve (3), wherein the plug connector (1) has an inner sleeve (4) with an open first axial inner sleeve end (4a) and an opposite open second axial inner sleeve end (4b), wherein a connecting portion (V) for connecting the inner sleeve (4) to the first fluid line (2a) is provided in the area of the first axial inner sleeve end (4a), wherein the second axial inner sleeve end (4b) encloses a receiving space (AR) into which an open first axial insertion sleeve end (3a) of the insertion sleeve (3) can be inserted axially, wherein an opposite open second axial insertion sleeve end (3b) of the insertion sleeve (3) can be connected to the second fluid line (2b), wherein the plug connector (1) has a locking mechanism for positive locking of the insertion sleeve (3) to the inner sleeve (4), wherein the locking mechanism comprises a locking recess (11) and a locking element (12), wherein the locking recess (11) connects an outer circumferential surface (AU4) of the inner sleeve (4) to the receiving space (AR), wherein, when the insertion sleeve (3) is in a defined coupling position in the receiving space (AR) of the inner sleeve (4), the locking element (12) within the locking recess (11) can be moved between an arresting position (SS) in which an arresting portion (12c) of the locking element (12) is in engagement with an engagement opening (13) arranged on the insertion sleeve (3), and a disengaged position (FS) in which the arresting portion (12c) is not in engagement with the engagement opening (13), wherein the plug connector (1) has a displacement sleeve (5) which is located outside the inner sleeve (4) in the radial direction and which can be displaced in the axial direction along the inner sleeve (4) between a parked position (PP), in which the locking mechanism is deactivated and a locking position (VP) in which the locking mechanism is activated, wherein the locking mechanism comprises a triggering spring (6) with an actuating portion (7) and a retaining portion (8), the triggering spring (6) being pretensioned in a retaining position (HP) in the parked position (PP) of the displacement sleeve (5), in which the retaining portion (8) is engaged on a retaining protrusion (9) of the inner sleeve (4), wherein the actuating portion (7) in the retaining position (HP) projects inwards in the radial direction into the receiving space (AR) of the inner sleeve (4) through an actuating opening (10) provided on the inner sleeve (4), wherein the actuating opening (10) is arranged between the locking recess (11) and the first axial inner sleeve end (4b) when viewed in the axial direction of the inner sleeve (4), wherein the actuating portion (7) of the triggering spring (6) can be displaced out of the receiving space (AR) in the radial direction by the insertion sleeve (3) when the insertion sleeve (3) is inserted into the receiving space (AR) of the inner sleeve (4), whereby the retaining portion (8) of the triggering spring (6) can be disengaged from the retaining protrusion (9) of the inner sleeve (4) and a triggering force (FA) directed in the direction of the second axial inner sleeve end (4b) acts on the displacement sleeve (5) from the triggering spring (6), by means of which the displacement sleeve (5) can be displaced from the parked position (PP) into the locking position (VP) and wherein a first guiding device (14) for guiding the locking element (12) is provided on the displacement sleeve (5), which is configured in such a way that when the displacement sleeve (5) is moved from the parked position (PP) into the locking position (VP), a first guiding force (FF1) acts on the locking element (12), by means of which the locking element (12) can be displaced from the disengaged position (FS) into the arresting position (SS).

2. The plug connector according to claim 1, wherein the displacement sleeve (5) can be manually displaced from the locking position (VP) back into the parked position (PP), preferably by means of a gripping portion (15) provided on the outer circumferential surface (AU5), whereby a compression force directed against the triggering force (FA) can be transmitted to the triggering spring (6), whereby the retaining portion (8) can be brought back into the retaining position (HP), wherein the first guiding device (14) of the displacement sleeve (5) is configured in such a way that when the displacement sleeve (5) is moved from the locking position (VP) into the parked position (PP), a second guiding force (FF2) acts on the locking element (12), by means of which the locking element (12) can be displaced from the arresting position (SS) into the disengaged position (FS).

3. The plug connector according to claim 1, wherein the triggering spring (6) has a restoring force (FR) in the area of the retaining portion (8) which is directed inwards in the radial direction of the inner sleeve (4) and by means of which the retaining portion (8) engages on the retaining protrusion (9) when the retaining position (HP) is reached and/or in that wherein a restoring protrusion (23) is provided on the inner circumferential surface of the displacement sleeve (5), which, when the displacement sleeve (5) is moved from the locking position (VP) into the parked position (PP), is configured to exert a restoring force (FR) on the triggering spring (6) which is directed inwards in the radial direction of the inner sleeve (4) and by means of which the retaining portion (8) of the triggering spring (6) engages on the retaining protrusion (9) when the retaining position (HP) is reached.

4. The plug connector (1) according to claim 1, wherein the triggering spring (6) has a spring wire with a first free wire end (6a), a second free wire end (6b) and with a central portion (6c) in between, wherein the central portion (6c) is in contact with the outer circumferential surface (UA4) of the inner sleeve (4) at least in portions and preferably extends in the circumferential direction over an angle of at least 30°, preferably at least 45°, particularly preferably at least 60°, in particular at least 90°, wherein the central portion (6c) is preferably substantially S-shaped or substantially V-shaped.

5. The plug connector (1) according to claim 4, wherein a fastening portion (17) is provided in the area of the first free wire end (6a), which is fastened to a fastening receptacle (18) arranged in the area of the first axial inner sleeve end on the outer circumferential surface (AU4) of the inner sleeve (4), and wherein the retaining portion (8) is provided in the area of the second free wire end (6b).

6. The plug connector (1) according to claim 4, wherein a stop protrusion (16) is provided on the inner circumferential surface (IU5) of the displacement sleeve (5), which is configured to form a stop for the second free wire end (6b) of the triggering spring (6) in the circumferential direction.

7. The plug connector (1) according to claim 1, wherein the locking recess (11) is configured as a circumferential groove and extends in the circumferential direction of the inner sleeve (4) over a groove angle (α) of at least 30°, preferably at least 60°, particularly preferably at least 90°, wherein the circumferential groove preferably lies in a plane which is perpendicular to the longitudinal axis of the inner sleeve (4).

8. The plug connector (1) according to claim 1, wherein an axial position of the locking recess (11) on the inner sleeve is determined depending on an axial position of the engagement opening (13) of the insertion sleeve (3) and/or wherein an axial position of the actuating opening (10) on the inner sleeve is determined depending on an axial position of a conical portion (19) of the insertion sleeve (3).

9. The plug connector (1) according to claim 1, wherein the first guiding device (14) of the displacement sleeve (5) comprises a first guiding link (14a) and a second guiding link (14b), which are arranged at a distance from one another in the circumferential direction of the displacement sleeve (5) on the inner circumferential surface (IU5) of the displacement sleeve (5), wherein the locking element (12) comprises a rod with a first free rod end and an opposite second free rod end, wherein a first guiding portion (12a) is provided in the area of the first rod end, which is positively guided in the first guiding link (14a), and a second guiding portion (12b) is provided in the area of the second rod end, which is positively guided in the second guiding link (14b), and wherein the arresting portion (12c) is located between the free rod ends.

10. The plug connector (1) according to claim 1, wherein the locking mechanism comprises at least two locking mechanisms of the same type, which are preferably arranged diametrically opposite each other on the plug connector (1) with respect to a longitudinal axis of the inner sleeve (4).

11. The plug connector (1) according to claim 1, wherein the connecting portion (V) of the first axial inner sleeve end comprises a number of engaging recesses (20) which are configured to interact with a plurality of corresponding engaging protrusions (21) provided on the first fluid line (2a), in order to form a positive locking connection in the axial direction and/or in the circumferential direction and/or wherein the connecting portion (V) of the first axial inner sleeve end (4a) comprises a plurality of engaging protrusions (21) which are configured to interact with a plurality of corresponding engaging recesses (20) provided on the first fluid line (2a) in order to form a positive-locking connection in the axial direction and/or in the circumferential direction.

12. The plug connector (1) according to claim 1, wherein a second guiding device is provided for axially guiding the displacement sleeve (5) along the inner sleeve (4), the second guiding device (22) preferably comprising at least one first guiding protrusion (22a) and at least one second guiding protrusion (22b), which are arranged at a distance from one another in the circumferential direction on the outer circumferential surface (AU4) of the inner sleeve (4) and comprises a guiding web (32), which is provided on the inner circumferential surface (IU5) of the displacement sleeve (5) and extends in the axial direction over at least part of a length of the displacement sleeve (5), wherein the guiding web (32) is guided in the circumferential direction between the first guiding protrusion (22a) and the second guiding protrusion (22b).

13. The plug connector (1) according to claim 1, wherein a plurality of positioning recesses (24) is provided on the inner sleeve (4), which each extend from the second axial inner sleeve end (4b) over a part of the inner sleeve in the direction of the first axial inner sleeve end (4a) and which each connect the inner circumferential surface (IU4) with the outer circumferential surface (AU4) of the inner sleeve (4), wherein the plurality of positioning recesses (24) is configured to co-operate with a plurality of corresponding positioning protrusions (25) provided on the insertion sleeve (3) in order to position the insertion sleeve (3) in the coupling position in the circumferential direction relative to the inner sleeve (4).

14. The plug connector (1) according to claim 1, wherein the plug connector (1) has an indicating device (A) to indicate to a user whether the displacement sleeve (5) is in the locking position (VP) and the locking element (12) is in the arresting position (SS).

15. The plug connector (1) according to claim 14, wherein the indicating device (A) comprises a plurality of signal tabs (26) which are arranged distributed around the circumference at the first axial inner sleeve end (4a), wherein the number of signal tabs (26) project beyond the first axial inner sleeve end (4a) in the axial direction, wherein the number of signal tabs (26) each comprise a signal surface (27), wherein in the parked position (PP) of the displacement sleeve (5) a first part of the signal surface is covered by the displacement sleeve (5) and in the locking position (VP) of the displacement sleeve (5) a smaller part of the signal surface (27) relative to the first part is covered by the displacement sleeve (5) or the signal surface (27) is completely exposed, wherein a machine-readable code, in particular a QR code, is preferably depicted on at least one of the signal surfaces (27), which code can be read by machine when the displacement sleeve (5) is in the locking position (VP).

16. The plug connector assembly comprising the plug connector (1) according to claim 1, a first fluid line (2a), an insertion sleeve (3) and preferably a second fluid line (2b).

17. The plug connector assembly according to claim 16, wherein the connecting portion (V) of the inner sleeve (4) is connected to the first fluid line (2a), the insertion sleeve (3) being positioned in the coupling position within the receiving space (AR) of the inner sleeve (4), wherein the displacement sleeve (5) is in the locking position (VP) and the at least one locking element (12) is in the arresting position (SS) and is engaged with the engagement opening (13) of the insertion sleeve (3), wherein the second axial insertion sleeve end (3b) is connected to the second fluid line (2b).

18. The plug connector assembly according to claim 17, wherein a first circumferential shoulder (28) with a first annular end face (28a) is provided on an inner circumferential surface of an end portion of the first fluid line (2a) connected to the connecting portion (V) of the inner sleeve (4), which faces the inner sleeve (4) in the axial direction, wherein a second circumferential shoulder (29) with a second annular end face (29a) is provided on the inner circumferential surface (IU4) of the inner sleeve (4), which faces the first fluid line (2a), wherein a sealing space (30), in which a sealing element (31) is arranged, is configured between the first annular end face (28a) and the second annular end face (29a) when viewed in the axial direction and between the inner circumferential surface (IU2) of the end portion of the first fluid line (2a) and an outer circumferential surface (AU3) of the insertion sleeve (3) when viewed in the radial direction.

19. A use method of using the plug connector (1) according to claim 1 for connecting a first fluid line (2a) to a second fluid line (2b), wherein the connecting portion (V) of the inner sleeve (4) of the plug connector (1) is connected to the first fluid line (2a) and that wherein an insertion sleeve (3) is connected to the second fluid line (2b) by means of the second axial insertion sleeve end (3b), wherein the first axial insertion sleeve end (3a) of the insertion sleeve (3) is inserted into the receiving space (AR) of the inner sleeve (4) of the plug connector (1) until the insertion sleeve (3) is in the coupling position, the retaining portion (8) of the triggering spring (6) being displaced from the receiving space (AR) by a conical portion of the insertion sleeve (3) during the insertion and the retaining portion (8) being released from the retaining position, wherein a triggering force (FA) is exerted on the displacement sleeve (5) by the retaining portion (8) after the release, by means of which force the displacement sleeve (5) is moved from the parked position (PP) into the locking position (VP), wherein a first guiding force (FF1) is exerted on the locking element (12) by the first guiding device (14) of the displacement sleeve (5) during the movement of the displacement sleeve (5) from the parked position (PP) into the locking position (VP), by which the locking element (12) is displaced within the locking recess (11) from the disengaged position (FS) into the arresting position (SS) and wherein the arresting portion (12c) of the locking element

(12) comes into engagement with an engagement opening (13) arranged on the insertion sleeve (3) in order to lock the insertion sleeve (3) positively with the inner sleeve (4) at least in the axial direction.

20. The use method according to claim 19, wherein the displacement sleeve (5) is manually displaced from the locking position (VP) back into the parked position (PP), preferably by means of a gripping portion (15) provided on the outer circumferential surface (AU5), wherein during the displacement via the displacement sleeve (5), a compression force directed in the opposite direction to the release force (FA) is exerted on the retaining portion (8) of the triggering spring (6), by means of which the retaining portion (8) is brought back into the retaining position (HP) and engages on the retaining protrusion (9), wherein during the movement of the displacement sleeve (5) from the locking position (VP) into the parked position (PP), a second guiding force (FF2) is exerted on the locking element (12) by the first guiding device (14), by which the locking element (12) is displaced from the arresting position (SS) back into the disengaged position (FS), whereby the arresting portion (12c) of the locking element (12) disengages the engagement opening (13) of the insertion sleeve (3) in order to reverse the positive locking.
